(19) United States
(12) Patent Application Publication
(10) Pub. No.: US 2013/0046695 A1
(43) Pub. Date: Feb. 21, 2013

(54) Systems and Methods for Energy Management Between a Utility Provider and a Consumer

(71) Applicants: Jesus Acosta-Cazaubon, Atlanta, GA (US); Kenneth Caird, Atlanta, GA (US); George Alexander, Atlanta, GA (US)

(72) Inventors: Jesus Acosta-Cazaubon, Atlanta, GA (US); Kenneth Caird, Atlanta, GA (US); George Alexander, Atlanta, GA (US)

(73) Assignee: GENERAL ELECTRIC COMPANY, Schenectady, NY (US)

(21) Appl. No.: 13/213,734

(22) Filed: Aug. 19, 2011

(51) Int. Cl. G06Q 20/00; H04L 9/32

(52) U.S. Cl. 705/63; 726/7

(57) ABSTRACT

Embodiments of the invention can provide systems and methods for energy management between a utility provider and a consumer. According to one embodiment of the invention, a system can be provided. The system can include a computer processor. The system can also include a memory operable to store computer-executable instructions operable for receiving a readable code associated with a utility meter, and further receiving a unique identifier associated with a mobile device; verifying that the readable code is associated with the unique identifier; and authorizing a consumer associated with the mobile device to access account information associated with the at least one utility meter.

### FIELD OF THE INVENTION

Embodiments of the invention relate generally to energy management, and more particularly to systems and methods for energy management between a utility provider and a consumer.

### BACKGROUND OF THE INVENTION

As the price of energy increases, finding ways to monitor, control, and conserve energy can be a priority. More often than not, consumers are usually unaware of the quantity of their power usage until they are billed by a utility provider. In other instances, consumers may be using more energy than they realize, or consumers may be unnecessarily using energy during peak hours, which can result in increased energy costs and/or occasional power outages due to lack of or reduced load capacity.

### BRIEF DESCRIPTION OF THE INVENTION

Some or all of the above needs and/or problems may be addressed by certain embodiments of the invention. Disclosed embodiments may include systems and methods for energy management between a utility provider and a consumer. According to one embodiment of the invention, there is disclosed a method for energy management between a utility provider and a consumer. The method can include registering a unique identifier of a mobile device with a utility provider; transmitting a readable code to the utility provider with the mobile device, wherein the readable code is associated with at least one utility meter having a readable code; and receiving an indication associated with verifying that the mobile device is associated with the readable code via the unique identifier of the mobile device.

According to another embodiment of the invention, there is disclosed another method for energy management between a utility provider and a consumer. The method can include associating a mobile device with at least one utility meter, wherein the mobile device comprises a unique identifier and the at least one utility meter comprises a readable code; receiving communications from the mobile device after the mobile device transmits the readable code associated with the at least one utility meter; verifying the mobile device is associated with the at least one utility meter; and authorizing the consumer to access account information associated with the at least one utility meter.

Further, according to another embodiment of the invention, there is disclosed an energy management system. The system can include a computer processor. The system can also include a memory operable to store computer-executable instructions operable for receiving a readable code associated with a utility meter, and further receiving a unique identifier associated with a mobile device; verifying that the readable code is associated with the unique identifier; and authorizing a consumer associated with the mobile device to access account information associated with the at least one utility meter.

Other embodiments, aspects, and features of the invention will become apparent to those skilled in the art from the following detailed description, the accompanying drawings, and the appended claims.

### BRIEF DESCRIPTION OF THE DRAWINGS

Reference will now be made to the accompanying drawings, which are not necessarily drawn to scale, and wherein:

FIG. 1 is a block diagram of a computer environment showing an illustrative system for implementing energy management between a utility provider and a consumer, according to an embodiment of the invention.

FIG. 2 is a schematic illustrating details of an example data flow for implementing energy management between a utility provider and a consumer, according to an embodiment of the invention.

FIG. 3 is a flow diagram illustrating details of an example method for implementing energy management between a utility provider and a consumer, according to an embodiment of the invention.

FIG. 4 is a flow diagram illustrating details of another example method for implementing energy management between a utility provider and a consumer, according to an embodiment of the invention.

### DETAILED DESCRIPTION OF THE INVENTION

Illustrative embodiments of the invention will now be described more fully hereinafter with reference to the accompanying drawings, in which some, but not all embodiments of the invention are shown. The invention may be embodied in many different forms and should not be construed as limited to the embodiments set forth herein; rather, these embodiments are provided so that this disclosure will satisfy applicable legal requirements. Like numbers refer to like elements throughout.

Illustrative embodiments of the invention are directed to, among other things, systems and methods for energy management between a utility provider and a consumer. Certain illustrative embodiments of the invention may be directed towards providing access to a consumer utility account by verifying that a readable code of a utility meter is associated with a unique identifier of a mobile device. For example, the unique identifier of the mobile device may be registered with the utility provider. The utility provider may then associate the unique identifier of the mobile device with the readable code of the utility meter. The mobile device may transmit the unique identifier of the mobile device and the readable code of the utility meter to the utility provider. The utility provider may then verify that the unique identifier of the mobile device is associated with the readable code of the utility meter. Upon verification, the mobile device may be granted access to the utility account.

In some embodiments, a consumer may register a unique identifier of a mobile device with a utility provider; transmit a readable code to the utility provider with the mobile device, wherein the readable code is associated with at least one utility meter; and receive an indication associated with verifying that the mobile device is associated with the readable code via the unique identifier of the mobile device.

Further, in some embodiments, a utility provider may associate a mobile device with at least one utility meter, wherein the mobile device comprises a unique identifier and the at least one utility meter comprises a readable code; receive communications from the mobile device after the mobile device transmits the readable code associated with the at least one utility meter; verify the mobile device is associated with the at least one utility meter; and authorize a consumer to access account information associated with the at least one utility meter.

In some aspects, the unique identifier of the mobile device may be a media access control address. In other aspects, the readable code may be a quick response (QR) code, a bar code, or an encrypted identification code. In still other aspects, the mobile device may be a smartphone, a mobile phone, a tablet device, or a handheld communication device. In other aspects, some or all communication may be performed on a secure platform. In still other aspects, the unique identifier of the mobile device may be registered with multiple utility providers.

Certain embodiments of the invention can provide a technical solution to facilitating energy management between a consumer and a utility provider. In one embodiment, a unique identifier for a mobile device associated with a consumer, and a readable code for a utility meter associated with a utility provider, can be associated together for purposes of authorizing a consumer's access to account information managed by the utility provider and associated with the utility meter. In this manner, certain embodiments of the invention can encourage and facilitate energy management.

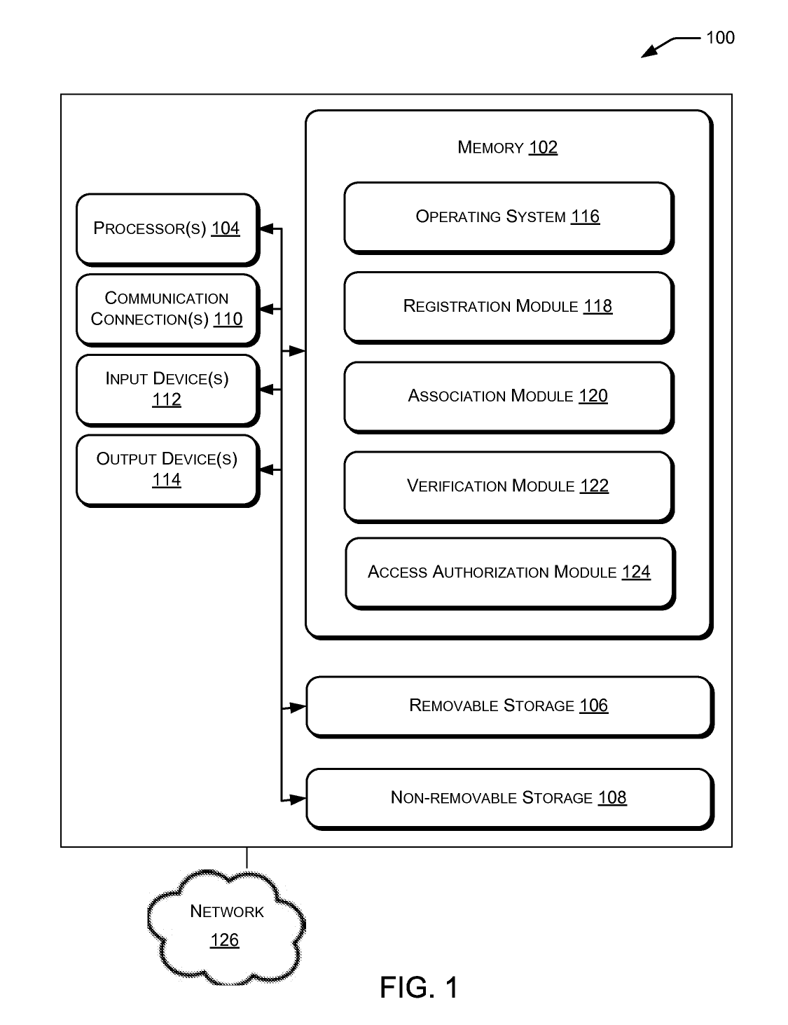

FIG. 1 provides an illustrative overview of a system, such as one computing device 100, according to an embodiment of the invention. The computing device 100 may be configured as any suitable computing device capable of implementing the disclosed features, and accompanying methods, such as, but not limited to, those described with reference to FIG. 1. By way of example and not limitation, suitable computing devices may include personal computers (PCs), servers, server farms, data centers, or any other device capable of storing and executing all or part of the disclosed features.

In one illustrative configuration, the computing device 100 comprises at least a memory 102 and one or more processing units (or processor(s)) 104. The processor(s) 104 may be implemented as appropriate in hardware, software, firmware, or combinations thereof. Software or firmware implementations of the processor(s) 104 may include computer-executable or machine-executable instructions written in any suitable programming language to perform the various functions described. Moreover, the processor 104 may be associated with a network, a server, a computer or a mobile device.

Memory 102 may store program instructions that are loadable and executable on the processor(s) 104, as well as data generated during the execution of these programs. Depending on the configuration and type of computing device 100, memory 102 may be volatile (such as random access memory (RAM)) and/or non-volatile (such as read-only memory (ROM), flash memory, etc.). The computing device or server may also include additional removable storage 106 and/or non-removable storage 108 including, but not limited to, magnetic storage, optical disks, and/or tape storage. The disk drives and their associated computer-readable media may provide non-volatile storage of computer-readable instructions, data structures, program modules, and other data for the computing devices. In some implementations, the memory 102 may include multiple different types of memory, such as static random access memory (SRAM), dynamic random access memory (DRAM), or ROM.

Memory 102, removable storage 106, and non-removable storage 108 are all examples of computer-readable storage media. For example, computer-readable storage media may include volatile and non-volatile, removable and non-removable media implemented in any method or technology for storage of information such as computer-readable instructions, data structures, program modules or other data. Memory 102, removable storage 106, and non-removable storage 108 are all examples of computer storage media. Additional types of computer storage media that may be present include, but are not limited to, programmable random access memory (PRAM), SRAM, DRAM, RAM, ROM, electrically erasable programmable read-only memory (EEPROM), flash memory or other memory technology, compact disc read-only memory (CD-ROM), digital versatile discs (DVD) or other optical storage, magnetic cassettes, magnetic tape, magnetic disk storage or other magnetic storage devices, or any other medium which can be used to store the desired information and which can be accessed by the server or other computing device. Combinations of any of above should also be included within the scope of computer-readable media.

Alternatively, computer-readable communication media may include computer-readable instructions, program modules, or other data transmitted within a data signal, such as a carrier wave, or other transmission.

The computing device 100 may also contain communication connection(s) 110 that allow the computing device 100 to communicate with a stored database, another computing device or server, user terminals, and/or other devices on a network 126. The computing device 100 may also include input device(s) 112 such as a keyboard, mouse, pen, voice input device, touch input device, etc., and output device(s) 114, such as a display, speakers, printer, etc.

Turning to the contents of the memory 102 in more detail, the memory 102 may include an operating system 116 and one or more application programs or services for implementing the features disclosed herein including a registration module 118. The registration module 118 may be configured to receive data regarding a unique identifier associated with a mobile device, such as, but not limited to, a media access control (MAC) address. Additionally, the registration module 118 may also store the unique identifier associated with the mobile device in the memory 102. In one aspect, the registration module 118 may receive the unique identifier associated with the mobile device through a website, kiosk, or other portal or network 126 accessible to the computing device 100.

The memory 102 may further include an association module 120. The association module 120 may be configured to associate a readable code of a utility meter with the unique identifier of a mobile device. Additionally, the association module 120 may also store the utility meter readable code and unique identifier association in the memory 102.

Additionally, the memory 102 may include a verification module 122. The verification module 122 may be configured to verify that a readable code of a utility meter is associated with a unique identifier of a mobile device, as performed in the association module 120.

The memory 102 may also include an access authorization module 124. The access authorization module 124 may be configured to provide access to a consumer account upon verification that a utility meter is associated with a unique identifier of a mobile device, as performed in verification module 122.

Various instructions, methods and techniques described herein may be considered in the general context of computer-executable instructions, such as program modules, executed by one or more computers or other devices. Generally, program modules include routines, programs, objects, components, data structures, etc., for performing particular tasks or implementing particular abstract data types. These program modules and the like may be executed as native code or may be downloaded and executed, such as in a virtual machine or other just-in-time compilation execution environment. Typically, the functionality of the program modules may be combined or distributed as desired in various embodiments. An implementation of these modules and techniques may be stored on some form of computer-readable storage media.

The example computing device 100 shown in FIG. 1 is provided by way of example only. Numerous other operating environments, system architectures, and device configurations are possible. Accordingly, embodiments of the present disclosure should not be construed as being limited to any particular operating environment, system architecture, or device configuration.

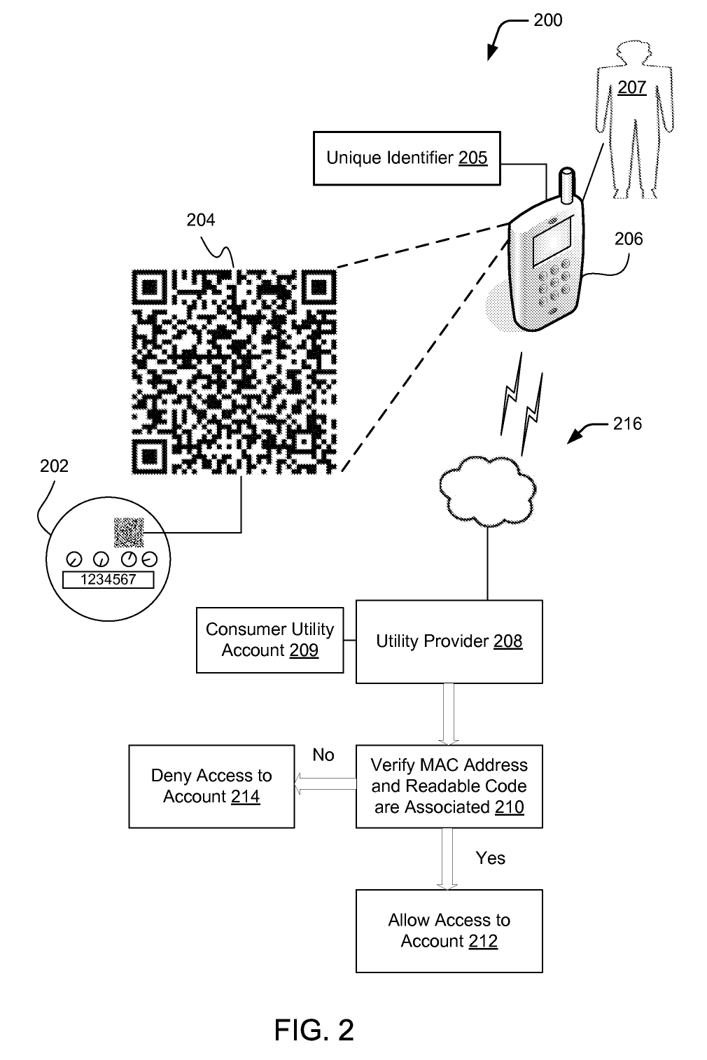

FIG. 2 is a schematic illustrating details of an example data flow 200 for facilitating energy management between a utility provider and a consumer in accordance with an embodiment of the invention. The example data flow 200 shown in FIG. 2 utilizes a utility meter 202 with a readable code 204, and a mobile device 206 with a unique identifier 205. The data flow 200 can facilitate providing access for a consumer 207 to a consumer utility account 209 associated with a utility provider 208. The consumer utility account 209 can include account information from the utility provider 208, such as energy usage information associated with the utility meter 202.

The data flow 200 begins by a consumer, such as 207, using a mobile device, such as 206, to scan a readable code 204 of the utility meter 202. The mobile device 206 can receive the readable code 204 or otherwise transmit the readable code 204 via a network 216 to a server or other processor-based device, such as a server at the utility provider 208, to verify that the readable code 204 of the utility meter 202 is associated with a unique identifier 205 of the mobile device 206. In the particular implementation shown in FIG. 2, the readable code 204 can be a quick response (QR) code, the unique identifier 205 of the mobile device 206 can be a media access control (MAC) address, and the mobile device 206 can be a smartphone. One may appreciate, however, that any readable code may be used, including, but not limited to, a bar code or an encrypted identification code. One may also appreciate that any unique identifier may be used, including, but not limited to, a phone number or IP address. One may further appreciate that any mobile device may be used, including, but not limited to, a mobile phone, a tablet device, or a handheld communication device.

Still referring to FIG. 2, in one aspect, the readable code 204 may be disposed on or about the utility meter 202. The mobile device 206 may scan the readable code 204 using a camera or other device capable of reading, sensing, detecting, or receiving a code. The unique identifier 205 of the mobile device 206 and the readable code 204 of the utility meter 202 are transmitted 216 to the utility provider 208. The utility provider 208 may then verify 210 that the unique identifier 205 of the mobile device 206 is associated with the readable code 204 of the utility meter 202. Upon verification, access 212 may be granted to the consumer utility account 209. Conversely, if the unique identifier 205 of the mobile device 206 is not associated with the readable code 204 of the utility meter 202, consumer access to the consumer utility account 209 may be denied 214.

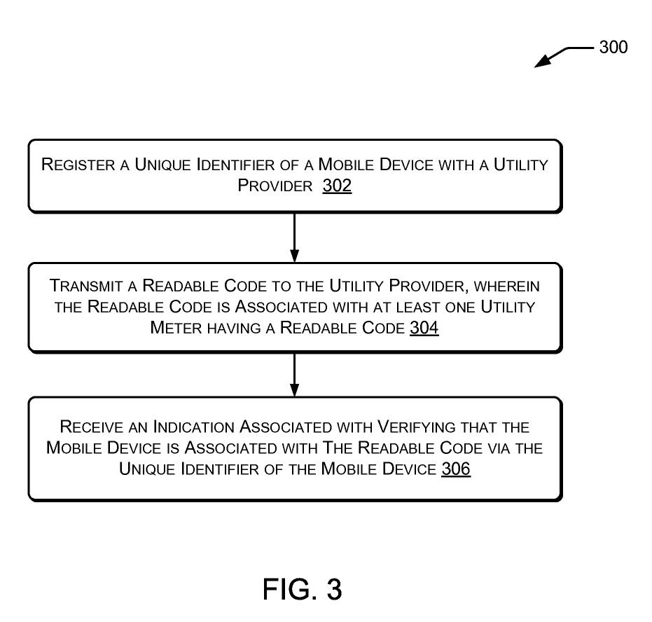

FIG. 3 illustrates an example flow diagram of a method 300 for implementing energy management between a utility provider and a consumer, in accordance with an embodiment of the invention. In one example, the illustrative computing device 100 of FIG. 1 and/or one or more modules of the illustrative computing device 100, alone or in combination, may perform the described operations of method 300.

In this particular implementation, the method 300 may begin at block 302 of FIG. 3 in which the method 300 may include the registration of a unique identifier of a mobile device with a utility provider. Further, at block 304, the method 300 may include the transmission of a readable code to the utility provider with the mobile device, wherein the readable code may be associated with at least one utility meter having a readable code. At block 306, the method 300 may include the receiving of an indication associated with verifying that the mobile device is associated with the readable code via the unique identifier of the mobile device.

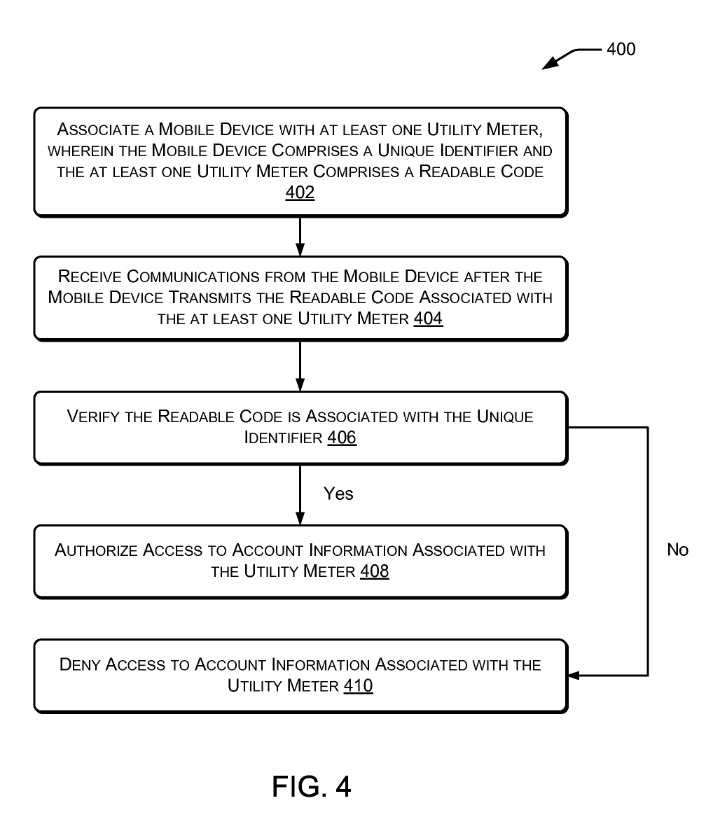

FIG. 4 illustrates another example flow diagram of a method 400 for implementing energy management between a utility provider and a consumer, in accordance with an embodiment of the invention. In one example, the illustrative computing device 100 of FIG. 1 and/or one or more modules of the illustrative computing device 100, alone or in combination, may perform the described operations of method 400.

In this particular implementation, the method 400 may begin at block 402 of FIG. 4 in which the method 400 may include the association of a mobile device with at least one utility meter, wherein the mobile device may comprise a unique identifier and the at least one utility meter may comprise a readable code. Further, at block 404, the method 400 may include receiving communications from the mobile device after the mobile device transmits the readable code associated with the at least one utility meter. At block 406, the method 400 may include verifying that the mobile device is associated with the at least one utility meter. Upon verification, at block 408, the method 400 may include authorizing the consumer to access account information associated with the at least one utility meter. Once a consumer is granted access to the utility account, the consumer may utilize the account. For example, the consumer may check the current energy usage of a premises associated with a particular utility meter, turn the account on or off, or pay a bill. Conversely, at block 410, if the readable code is not associated with the unique identifier of the mobile device, access may be denied to the consumer account.

Illustrative systems and methods are described for providing access to a consumer utility account by verifying that the readable code of the utility meter is associated with a unique identifier of the mobile device. Some or all of these systems and methods may, but need not, be implemented at least partially by architectures such as those shown in FIG. 1 above.

Although embodiments have been described in language specific to structural features and/or methodological acts, it is to be understood that the disclosure is not necessarily limited to the specific features or acts described. Rather, the specific features and acts are disclosed as illustrative forms of implementing the embodiments.

1. A method of energy management between a utility provider and a consumer, comprising:
registering a unique identifier of a mobile device with the utility provider, wherein the unique identifier is associated with the consumer;
transmitting a machine-readable code to the utility provider with the mobile device, wherein the machine-readable code is associated with at least one utility meter having a machine-readable code;
receiving an indication associated with verifying that the mobile device is associated with the machine-readable code via the unique identifier of the mobile device; and
accessing, by the consumer, account information associated with the at least one utility meter via the mobile device.

2. The method of claim 1, wherein the unique identifier of the mobile device is a media access control address.

3. The method of claim 1, wherein the machine-readable code comprises a quick response (QR) code, a bar code, or an encrypted identification code.

4. The method of claim 1, wherein the mobile device is a smartphone, a mobile phone, a tablet device, or a handheld communication device.

5. The method of claim 1, further comprising:
upon or after receipt of the indication, accessing account information from the utility provider.

6. The method of claim 1, wherein registering, transmitting, and receiving is performed using a secure platform.

7. The method of claim 1, further comprising:
registering the unique identifier of the mobile device with multiple utility providers.

8. A method of energy management between a utility provider and a consumer, comprising:
associating a mobile device with at least one utility meter, wherein the mobile device comprises a unique identifier, wherein the unique identifier is associated with the consumer, and wherein the at least one utility meter comprises a machine-readable code;
receiving communications from the mobile device after the mobile device transmits the machine-readable code associated with the at least one utility meter;
verifying the mobile device is associated with the at least one utility meter;
authorizing the consumer to access account information associated with the at least one utility meter; and
accessing, by the consumer, the account information via the mobile device.

9. The method of claim 8, wherein the unique identifier of a mobile device is a media access control address.

10. The method of claim 8, wherein the machine-readable code comprises a quick response (QR) code, a bar code, or an encrypted identification code.

11. The method of claim 8, wherein the mobile device comprises a smartphone, a mobile phone, a tablet device, or a handheld communication device.

12. The method of claim 8, wherein verifying the mobile device is associated with the at least one utility meter comprises:
verifying the unique identifier of the mobile device is associated with the machine-readable code of the at least one utility meter.

13. The method of claim 8, wherein all communication is performed on a secure platform.

14. An energy management system, comprising:
a computer processor; and
a memory in communication with the computer processor operable to store computer-executable instructions operable to:
receive a machine-readable code associated with a utility meter, and to further receive a unique identifier associated with a mobile device;
verify that the machine-readable code is associated with the unique identifier; and
authorize a consumer associated with the mobile device to access account information associated with the at least one utility meter, wherein the account information is accessible to the consumer via the mobile device.

15. The system of claim 14, wherein the computer processor is associated with a server or a computer.

16. The system of claim 14, wherein the computer processor is associated with the mobile device.

17. The system of claim 14, wherein the unique identifier of the mobile device is a media access control address.

18. The system of claim 14, wherein the machine-readable code comprises a quick response (QR) code, a bar code, or an encrypted identification code.

19. The system of claim 14, wherein the mobile device comprises a smartphone, a mobile phone, a tablet device, or a handheld communication device.

20. The method of claim 14, wherein all communication is performed on a secure platform.
